(19) United States
(12) Patent Application Publication
(10) Pub. No.: US 2025/0276647 A1
(43) Pub. Date: Sep. 4, 2025

(54) BOARDING SYSTEM WITH ADAPTER FRAME

(71) Applicant: Bode - Die Tür GmbH, Kassel (DE)

(72) Inventors: Marco Cimmino, Adelebsen (DE); Christoph Theis, Bad Wildungen (DE); Ulrich Arend, Dickershausen (DE); Dirk Winterfeld, Kassel (DE)

(21) Appl. No.: 19/051,935

(22) Filed: Feb. 12, 2025

(30) Foreign Application Priority Data
Mar. 4, 2024 (DE) 20 2024 101 038.8

(51) Int. Cl. B60R 3/02

(52) U.S. Cl. CPC B60R 3/02

(57) ABSTRACT

A boarding system for vehicles, in particular for public transport vehicles, includes a step box with a box frame and a step plate module, which can be moved relative to the box frame. The boarding system includes an adapter frame, into which the box frame can be inserted, wherein the box frame has a vehicle-independent size. The adapter frame has a vehicle-dependent size for adapting the boarding system to a vehicle-side receptacle. so that the adapter frame can be inserted in the vehicle-side receptacle.

### CROSS-REFERENCE TO RELATED APPLICATIONS

This application claims the benefit of German patent application 20 2024 101 038.8 filed on 4 Mar. 2024, the disclosure of which is incorporated herein by reference in its entirety.

### TECHNICAL FIELD

The present disclosure relates to a boarding system for vehicles, in particular for public transport vehicles, comprising a step box with a box frame and a step plate module, which can be moved relative to the box frame.

### BACKGROUND

Boarding systems are used for making it easier for individuals to get on as well as get off a vehicle. A “boarding” can thus be understood to be the getting on as well as the getting off the vehicle. In terms of the disclosure, a public transport vehicle can be, for example, a rail vehicle, in particular a train, a light rail, a tram or an underground railway, etc. Such a vehicle can also be a wheel-bound vehicle, such as, for example, a bus. Boarding systems often make it easier to get on in that they reduce a gap between a platform (stop, sidewalk, road) and the vehicle and/or compensate for a height difference between vehicle and platform. Boarding systems can be formed, for example, in the form of sliding step systems or folding step systems. Combined systems are also known. The present case aims in particular at sliding step systems.

Depending on vehicle type, vehicle size or also depending on customer requirements, the installation space available for a boarding system can vary. There is therefore an increased need for a simple and flexible adaptation of boarding systems or the corresponding step boxes, respectively, to the installation space available in a vehicle. The floor integration is currently realized by means of a box frame made of aluminum profiles, the size of which box frame is adapted to the respective vehicle. Contours for guiding the extension module or the step plate module, respectively, as well as for the integration of the step box into the floor of the vehicle as well as for receiving a maintenance cover are generally integrated into the aluminum profiles. A new design or re-design, respectively, of the step box including the box frame thereof is thus generally required for adapting the step box to the different vehicles, which is associated with a significant planning effort and high costs.

### SUMMARY

The present disclosure is thus based on providing a boarding system, which can be adapted easily and cost-efficiently to the structural conditions of the vehicle, in which the boarding system is to be used. The boarding system is to further be capable of being adapted to customer requirements in a flexible manner. The vehicle proposed according to the disclosure is based on the same objective.

The mentioned objective is solved by providing a boarding system as well as a vehicle according to the independent claims.

The boarding system according to the disclosure for vehicles is in particular suitable for public transport vehicles. The boarding system comprises a step box, wherein the step box comprises a box frame and a step plate module. In addition to the step box, the boarding system according to the disclosure also comprises an adapter frame, into which the box frame can be inserted. The box frame and/or the adapter frame can have fastening means for the connection, in particular releasable connection, of the box frame to the adapter frame. The box frame of the step box has a vehicle-independent size, whereas the adapter frame has a vehicle-dependent size. The adapter frame can be inserted in a vehicle-side receptacle. It can have fastening means for the connection, in particular releasable connection, of the adapter frame to the vehicle-side receptacle. The vehicle-side receptacles of different vehicles have a vehicle-dependent size. With regard to its size, the adapter frame is thus formed in a vehicle-dependent manner for the size-dependent adaptation of the boarding system to the vehicle-side receptacle.

The boarding system is formed essentially from the step box and the adapter frame. Due to the vehicle-independent size of the box frame, the step box can be used in different vehicles because the adapter frame has a vehicle-dependent size and adapts the step box to the different sized vehicle-side receptacles of the different vehicles in terms of size in this way.

In terms of the application, the vehicle-dependent or vehicle-independent size, respectively, of the frames (adapter frame, box frame) essentially aims at the external dimensions and the external shape of the frames. For example, a width, a height and/or a length of the adapter frame are adapted to the dimensions of the vehicle-side receptacle. A profile, which is adapted to the vehicle-side receptacle, can likewise be used for the production of the adapter frame, such as, for example, a wider and/or higher profile or a profile with a different cross section and/or a different shape. In terms of the application, the wording that the adapter frame is formed in a vehicle-dependent manner with regard to its size, refers to all of these adaptations.

The boarding system is in particular formed in a modular manner. This means that the step box can be combined with a plurality of different sized adapter frames to form a boarding system consisting of a step box and an adapter frame. The adapter frame is thereby adapted to the size of the vehicle-side receptacle, while the box frame and in particular the entire step box is always formed so as to be of identical size, independently of the vehicle. The same step box can be used in this way for every application or for every vehicle, respectively, and can be combined with an adapter frame, which is adapted to the vehicle-side receptacle. Only the size of the adapter frame thus has to be adapted in a vehicle-specific manner, so that a cost-intensive and complex re-design of the step box or of the box frame, respectively, can be dispensed with.

The vehicle-independent size of the box frame thus has the effect that a certain size of the box frame can be used for several different vehicles with different sized vehicle-side receptacles. The box frame and therefore in particular also the entire step box thus has some kind of a standard size, which can be used in many different vehicles.

The box frame, in contrast, is not adapted to the vehicle-side receptacle. Its size, thus essentially its external dimensions as well as the external shape are identical for different vehicles with different sized vehicle-side receptacles.

According to one design of the disclosure, it can be provided that the box frame and/or the adapter frame has/have tabs for the connection of the box frame to the adapter frame. The tabs preferably serve the purpose of receiving screw connections, so that the box frame can be screwed to the adapter frame. For this purpose, the tabs can in each case have bores and/or elongated holes and/or threads, which, together with screws and, where necessary nuts, form the screw connections. Corresponding bores, elongated holes and/or threads can be provided in the respective other component (box frame and/or adapter frame) to form the screw connection.

The tabs or at least a portion of the tabs can also be used for fastening further components to the box frame and/or the adapter frame.

The tabs or at least a portion of the tabs can also serve the purpose of additionally fastening the step box to the vehicle and in particular to the vehicle-side receptacle.

The tabs are in particular formed in one piece with the box frame. In one piece means that the tabs are not attached subsequently to the box frame as additional component. The tabs can be produced, for example, by shaping certain regions of the box frame, for example by lasering and subsequently bending the tabs out of the box frame. Provided that the box frame is formed as cast part, the tabs can be formed directly in the casting process as well.

The tabs protrude from the box frame, so that a simple fastening of the box frame to the adapter frame can be attained via the tabs. The tabs thereby preferably protrude at an angle of 80 to 100°, in particular 90°, from a surface of the box frame. The tabs in particular protrude beyond the box frame or the profile thereof, respectively, so that the tabs can overlap with the adapter frame.

The tabs are preferably punched or lasered into the box frame during the production of the box frame and are then bent out, edged out and/or erected.

The box frame is preferably embodied as a laser-edge component. In contrast to, for example, certain aluminum profiles, it is thus not extruded or continuously cast, so that no large tools are necessary for producing the box frame. The profiles and the tabs for the box frame are initially lasered in their unfolded or unwound form, respectively, from a flat plate during the production of laser-edge components and are subsequently shaped by means of one or several shaping processes to form a three-dimensional profile, such as, for example, a C-profile, and the tabs are erected or bent out, respectively.

The length of the tabs in particular corresponds maximally to a height of the box frame. The external shape of the box frame is generally rectangular and corresponds to a flat cuboid, wherein the height of the cuboid is much smaller than its width and its length.

Depending on the application, it is likewise conceivable that the tabs are welded or screwed to the box frame. The tabs can be formed, for example, in the form of L-brackets or as flat bars, which can be fastened to the box frame with the help of screw connections or welded joints.

The box frame can be formed as an essentially rectangular frame with four legs. The legs can be made from rectangular pipes, C-profiles, U-profiles and/or other profile shapes. These are, in particular, metal pipes or metal profiles, respectively. C-profiles are particularly preferred thereby.

The box frame does not have to be closed completely on all four sides. It is also conceivable that the box frame has an opening in one leg, for example for the guide-through of the step plate module, or also comprises only three legs, so that the step plate module can be extended on the side of the rectangular box frame, on which no leg or profile, respectively, is located. For this purpose, the box frame as a whole can, for example, form a U-shape or C-shape with the help of three legs. The open side, thus where no pipe or profile is provided, can be reinforced by means of a strut, wherein the strut is arranged and/or configured in such a way that it provides for the extension of the step plate module. Such a strut can be formed, for example, as a flat bar, a round bar, a tension strut or the like. To provide for the extension of the step plate module, the cross sectional profile of the strut can be smaller than the cross sectional profile of the remaining pipes or of the profiles of the box frame. It is also conceivable, however, that the strut or the fourth pipe or the fourth profile, respectively, is arranged in a different plane than the other three pipes or profiles, respectively, of the box frame, in order to provide for the extension of the step plate module in the plane of the three pipes or profiles, respectively, of the box frame in this way.

The step box can in particular comprise a box housing, which is fastened to the box frame. The box housing can be made of metal, plastic, composite materials and/or other suitable materials. The box housing can be configured in such a way that it essentially delimits the step box towards the surrounding area, that is, protects it against environmental influences, such as contaminations, moisture, solar radiation and the like. The box housing is thus in particular formed so as to be essentially closed. However, various functional openings can nonetheless be provided in the box housing thereby, through which, for example, the step box can be fastened or maintained, or through which the step plate module can be extended.

Due to the fact that the step plate module is part of the step box, the adapter frame in particular does not have any guide profiles or guide rails for extending the step plate module. The step box or the modules thereof, respectively, and in particular the box frame is responsible for this task. The adapter frame can be designed very simply in this way.

A step box formed in such a way can also provide for a significantly simplified assembly because the electrical contacting of the drive module can take place via standardized plug elements and the fastening of the step box in the adapter frame can likewise take place via standardized fastening means. An adaptation of the fastening elements of the step box or of the box frame, respectively, to the vehicle-side receptacle, as has been common practice so far, can thus be dispensed with. The same applies for the maintenance of the step box, which can likewise be simplified significantly due to the simple assembly/disassembly.

As already mentioned, different vehicles have different sized vehicle-side receptacles for the boarding system. The vehicle-side receptacles can differ from one another in their size, for example depending on their manufacturer, depending on their model, depending on their design or depending on customer requirement. This means that the vehicle-side receptacles can be of different widths, depths and/or heights and can have different shapes.

Without adapter frame, the step box according to the disclosure or the box frame according to the disclosure, respectively, of the present application is not suitable for the floor integration. A joint or a gap around the step box would develop in the floor of the vehicle because a floor integration, for example by means of moldings on the box frame, is not provided. The external shape of the box frame can be kept very simple in this way. As will be described below, the floor integration is the task of the adapter frame.

The adapter frame is adapted to the shape of the box frame, so that the box frame and thus the entire step box can be arranged in the adapter frame. A box receptacle can be provided on the adapter frame for this purpose. The box receptacle can be a recess in the adapter frame, in which the step box can be received completely.

In an installed state as intended, the adapter frame is arranged together with the step box in the vehicle below a floor of the vehicle. The floor of the vehicle refers to the floor in the vehicle interior, onto which the individuals located in the vehicle step. In particular a cover of the boarding system can thereby form a portion of the floor of the vehicle and can be arranged so as to be aligned therewith in the installed state of the boarding system as intended. The cover then essentially closes the vehicle-side receptacle towards the top.

The installed state as intended is the state, in which the boarding system is installed in the vehicle in a fully functional manner. This means that all assembly groups/modules of the boarding system are installed correctly in the vehicle and that the boarding system is operational.

The adapter frame can have fastening means, with the help of which the adapter frame can be connected to the vehicle via the vehicle-side receptacle. The fastening means can comprise, for example, screw connections, positive connections, snap hook connections and the like. For this purpose, corresponding portions of the fastening means, such as, for example, moldings, openings, threads or stay bolts can also be provided on the vehicle on the vehicle-side receptacle. Screw connections can be preferred because they are cost-efficient and offer a simple assembly/disassembly while simultaneously being of high strength. Openings, through which the screws of the screw connection can be inserted and which can form the screw connection in connection with suitable nuts or threads, can be provided on the adapter frame as well as on the vehicle-side receptacle.

Other fastening means are also conceivable, for example riveted connections or adhesive connections.

The box frame and/or the adapter frame can comprise fastening means for the in particular releasable connection of the box frame to the adapter frame. Corresponding fastening means can be provided so that the box frame can be fastened to the adapter frame. The fastening means can comprise moldings on the box frame and/or the adapter frame, as well as screw connections, positive connections, snap hook connections and the like. The same fastening means can be used, which have also already been proposed for the connection of adapter frame and vehicle-side receptacle.

The step plate module is configured so as to be movable relative to the box frame. The step plate module can be moved manually (by hand/muscle strength) or in an automated manner. So that the step plate module can be moved, the step box can comprise an extension module for movably mounting the step plate module on the box frame. The step box can comprise a drive module for the automated movement.

The extension module can be, for example, an extension frame, extension rails or linear guides, which are connected to the box frame on the one hand and to the step plate module on the other hand. The step plate module can be formed in one or several pieces and serves as extendable step for the passengers getting on and off. The step plate module is thus formed to the effect that it can absorb the weight of boarding individuals. The step plate module, e.g., a step plate, can be extended from a retracted position in the direction of an extended position and vice versa via the drive module.

According to a further design of the disclosure, it can be provided that the box frame is made of stainless steel, preferably of stainless steel profiles. A box frame made of stainless steel has the advantage that it is less susceptible to corrosion and can thereby additionally be cleaned much more easily. This is advantageous because the box frame can come into contact with salt water and contaminations during operation.

According to a further design of the disclosure, it can be provided that the adapter frame is made of aluminum, in particular of aluminum profiles. In particular extruded or continuously cast aluminum profiles lend themselves for the adapter frame. It can likewise be provided that only a portion of the adapter frame is made of aluminum profiles.

According to a further design of the disclosure, it can be provided that the adapter frame is configured in such a way that it can be integrated completely into a floor of the vehicle. In terms of the application, being capable of being integrated completely into the floor means that a top side of the adapter frame is arranged so as to be aligned with the floor of the vehicle. In other words, the adapter frame is oriented to the floor and is arranged in the vehicle-side receptacle so that it is essentially integrated into the surface of the floor and trip edges are thereby not created in the floor or in the surface of the floor, respectively, due to the adapter frame.

According to a further design of the disclosure, it can be provided that the boarding system comprises a cover for covering a top side of the step box, wherein the cover can be inserted into a cover receptacle in the adapter frame for this purpose. The cover serves the purpose of providing for the maintenance of the boarding system and in particular of providing for the maintenance of the step box or the components thereof, respectively. The cover can thus also be referred to as maintenance cover. The cover can be fastened to the adapter frame in particular with the help of hinges, so that the cover is formed so as to be capable of being opened by means of hinges. However, the cover can also be formed so as to be capable of being removed completely.

The cover closes the boarding system to the top and serves as step surface in the floor of the vehicle. In particular in an installed state of the boarding system in the vehicle as intended, the cover is thus arranged so as to be aligned with a floor of the vehicle, so that the cover forms at least a portion of the floor of the vehicle. As already described above for the adapter frame, the cover can thereby be integrated completely into the floor of the vehicle. The cover closes in particular an opening in the floor of the vehicle, through which the boarding system can be integrated into the floor.

The cover in particular has an anti-slip surface. The cover can also have a surface, which is identical to the surface of the floor of the vehicle. The surface structure and/or a surface material of the cover can thereby be formed so as to be identical to a surface structure and/or to a surface material of the floor.

According to a further design of the disclosure, it can be provided that the drive module and/or the extension module and/or the step plate module have a vehicle-independent size. The modules thereby have a size, which is identical for each vehicle. A complex and cost-intensive size adaptation of the modules is thus avoided.

The entire step box in particular has a vehicle-independent size. The features aim at the step box and its components or assembly groups/modules, respectively, having standard sizes, which are not specifically/individually adapted to a vehicle. Costs and storage space can be saved and flexibility can be gained with the use of standard-sized step boxes.

According to a further design of the disclosure, an electrical plug element arranged on the adapter frame can be provided, which is configured for cooperating with a vehicle-side electrical plug element corresponding thereto and for supplying the step box or the drive module, respectively, with electrical energy and/or for providing a data exchange. At this point, “plug elements” corresponding to one another is to be understood as the provision of a plug connection in terms of a plug and socket principle. The vehicle-side plug element is connected to a vehicle-side electrical energy source and/or to a data processing unit. The adapter frame-side plug element is connected electrically and/or via signals to the drive module. The connection between the adapter frame-side plug element and the drive module can be ensured by means of a further plug connection, a cable or other electrical connecting means or signal connecting means, respectively.

It is important to emphasize that the object on which the disclosure is based is also solved by providing a vehicle, in particular a public transport vehicle, which has a boarding system according to the disclosure.

A modular construction kit for boarding systems can also be comprised by the disclosure. The box frame or the entire step box, respectively, is provided in a limited number of different sizes in such a modular construction kit. For example, box frames can be provided in three different sizes: small, medium and large. The limited number of different sized step boxes resulting therefrom can be combined with a plurality of adapter frames, so that a modular construction kit results for the boarding system, in the case of which a selection can be made among the three different sized step boxes and the plurality of adapter frames, so that the boarding system can be used in a large plurality of different vehicles. At least 5 or at least 10 different sized adapter frames are in particular provided for each step box, which are in each case adapted in terms of size to a certain vehicle-side receptacle.

### BRIEF DESCRIPTION OF THE DRAWINGS

The disclosure will be explained further below on the basis of drawings, in which:

FIG. 1 shows a section of a vehicle with a boarding system in an installed state as intended in the vehicle,

FIG. 2 shows the boarding system from FIG. 1,

FIG. 3 shows a section of the step box of the boarding system from FIG. 1, and

FIG. 4 shows a section of the step box of the boarding system from FIG. 1 with adapter frame arranged thereon.

### DETAILED DESCRIPTION OF THE DRAWINGS

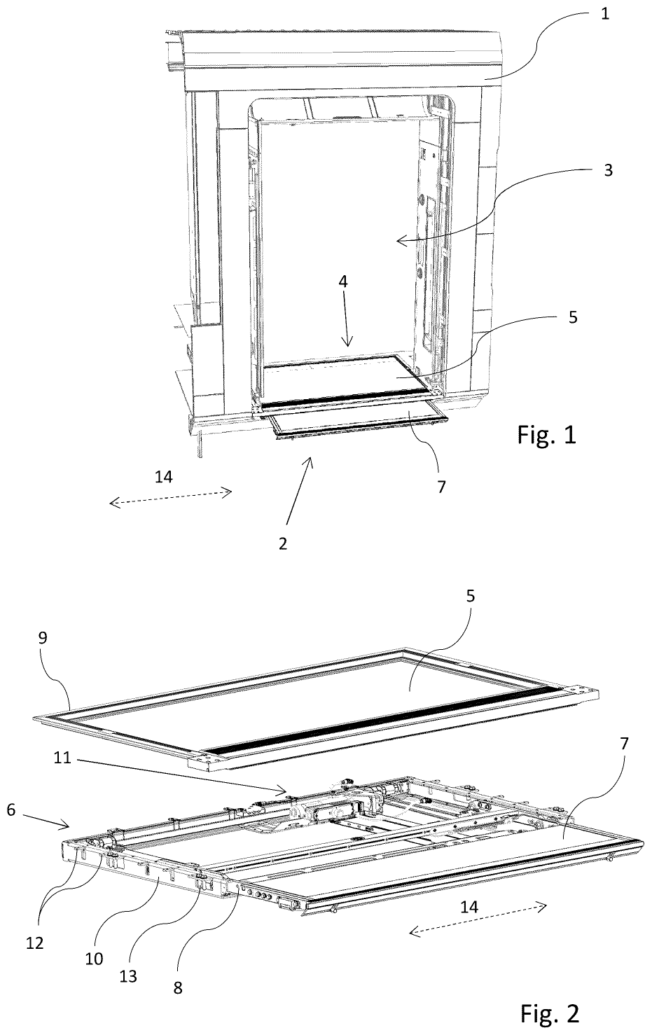

FIG. 1 shows a section of a vehicle 1 with a boarding system 2 in an installed state as intended. In this case, the vehicle 1 is a public transport rail vehicle. The vehicle 1 has a door opening 3, wherein the boarding system 2 is embedded below the door opening 3 in a floor 4 of the vehicle 1 and is arranged in a vehicle-side receptacle. The boarding system 2 is thereby integrated completely into the floor 4 and, as intended, serves the purpose of making it easier for passengers to get on and off. The boarding system 2 is integrated into the floor 4 of the vehicle 1 in such a way that no tripping points are present between boarding system 2 and floor 4, and a top side of the boarding system 2 is arranged so as to be aligned with the floor 4.

The boarding system 2 comprises a cover 5, which forms a portion of the floor 4 because the cover 5 spans the vehicle-side receptacle in the floor 4, which is open to the top. The cover 5 additionally covers a step box 6 to the top, so that the passengers do not step onto the step box 6 itself. The step box 6 is covered by the cover 5 in FIG. 1 and is thus not visible. The top side of the cover 5 essentially forms the top side of the boarding system 2, wherein the top side of the cover 5 is arranged so as to be aligned with the floor 4.

A step plate module 7 with a partially extended step surface is illustrated below the cover 5 or the plane of the floor 4, respectively. The step plate module 7 can extend when the vehicle 1 stops, so that getting on and off is simplified for the passengers. The passengers can thereby use the step surface of the step plate module 7 as step or tread, respectively.

The setup of the boarding system 2 from FIG. 1 is illustrated in more detail in FIG. 2. The boarding system 2 is constructed from the step box 6 and an adapter frame 9, wherein these two assembly groups are illustrated spaced apart from one another in FIG. 2. In addition to the step plate module 7, the step box 6 comprises a drive module 11 for automatically retracting and extending the step plate module 7, an extension module 8 formed as linear guide for the movable mounting of the step plate module 7, and a box frame 10. The box frame 10 is fastened to the adapter frame 9 with the help of tabs 12 and screw connections 13 (see in particular FIG. 4 with regard to this).

The cover 5 is arranged in a cover receptacle in the adapter frame 9 and is releasably connected thereto. In the installed state of the boarding system 2 as intended, the cover 5 can be removed from the adapter frame 9, so that the access to the modules of the step box 6 therebelow is made possible. The adapter frame 9 thereby remains fixedly connected to the step box 6 and the vehicle 1.

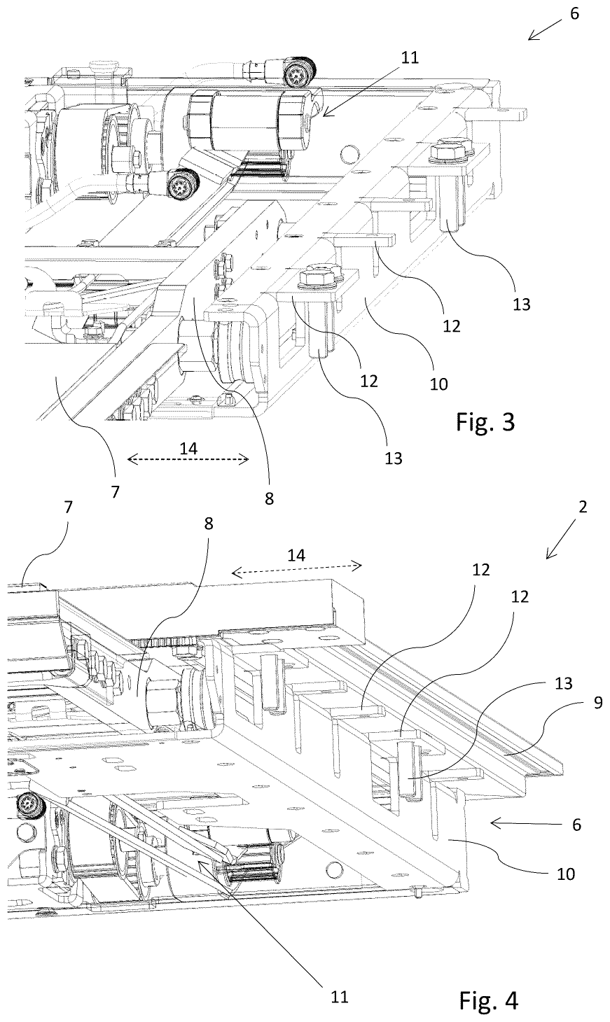

FIG. 3 shows a section of the step box 6 of the boarding system 2 from FIG. 1 without adapter frame 9. The step box 6 is illustrated obliquely from the top. The tabs 12, which are formed in one piece with the box frame 10, can be seen well here. The box frame 10 is made from C-profiles, which can be seen very well by the C-shaped cross section of the profiles with a horizontal top side, a horizontal bottom side and a perpendicular side surface connecting the horizontal top side to the horizontal bottom side. The tabs 12 are lasered from the perpendicular side surfaces of the C-profiles of the box frame 10 and are bent to top into a horizontal position. The tabs 12 are arranged at a 90° angle to the perpendicular side surfaces of the C-profiles and are aligned with the horizontal top sides of the C-profiles.

The tabs 12 have openings, through which the screw connections 13 can be inserted, so that the box frame 10 and the adapter frame 9 can be releasably connected to one another. The screws of the screw connections 13 are inserted through the openings of the tabs 12 only in an exemplary manner in FIG. 3. In the installed state as intended, the screws are initially inserted through the adapter frame 9 and are fixed from below by means of nuts, provided that no treads are provided in the openings of the tabs 12 of the box frame 10.

FIG. 4 shows the step box 6 with adapter frame 9 fastened thereto obliquely from below. The fastening of the box frame 10 to the adapter frame 9 via the tabs 12 can be seen well here. The screws of the screw connections 13 are inserted through corresponding openings in the adapter frame 9. The nuts for securing the screws are not illustrated.

The extension module 8 with its linear guides can be seen well. The step plate module 7 is connected directly to the drive module 11. The drive module 11 can extend the step plate module 7 laterally, that is, transversely to the driving direction 14 of the vehicle 1, from the vehicle 1 with the help of the linear guides.

1. A boarding system for vehicles, the boarding system comprising a step box with a box frame and a step plate module, configured to be moved relative to the box frame, wherein
the boarding system comprises an adapter frame, into which the box frame is configured to be inserted, wherein
the box frame has a vehicle-independent size, and wherein
the adapter frame has a vehicle-dependent size for adapting the boarding system to a vehicle-side receptacle, so that the adapter frame can be inserted in the vehicle-side receptacle.

2. The boarding system according to claim 1, wherein
the box frame and/or the adapter frame has/have tabs for the connection of the box frame to the adapter frame.

3. The boarding system according to claim 2, wherein
the tabs are formed in one piece with the box frame.

4. The boarding system according to claim 1, wherein
the box frame is made of stainless steel.

5. The boarding system according to claim 1, wherein
the adapter frame is made of aluminum.

6. The boarding system according to claim 1, wherein
the boarding system comprises a cover for covering a top side of the step box, wherein the adapter frame has a cover receptacle, into which the cover is configured to be inserted.

7. The boarding system according to claim 6, wherein
in an installed state of the boarding system in the vehicle as intended, the cover is configured to be inserted so as to be aligned with a floor of the vehicle and the cover is configured for forming at least a portion of the floor.

8. The boarding system according to claim 6, wherein
the cover has an anti-slip surface.

9. The boarding system according to claim 1, wherein
the step plate module has a vehicle-independent size.

10. The boarding system according to claim 1, wherein
the entire step box has a vehicle-independent size.

11. A boarding system for vehicles the boarding system comprising a step box with a box frame and a step plate module, configured to be moved relative to the box frame, wherein
a single box frame is configured to be inserted into a plurality of different adapter frames with different dimensions, wherein the different adapter frames are embodied such that the different adapter frames are configured to each be used with other vehicles with other installation dimensions.

12. A vehicle with a boarding system according to claim 1.
